(19) United States
(12) Patent Application Publication
(10) Pub. No.: US 2015/0046414 A1
(43) Pub. Date: Feb. 12, 2015

(54) COMPUTER PRODUCT, MANAGING APPARATUS, AND MANAGING METHOD

(71) Applicant: FUJITSU LIMITED, Kawasaki-shi (JP)

(72) Inventors: Daisuke KIKUOKA, Yokohama (JP); Koji NAKAZONO, Yokohama (JP); Seiji ENDO, Kawasaki (JP)

(73) Assignee: FUJITSU LIMITED, Kawasaki-shi (JP)

(21) Appl. No.: 14/337,608

(22) Filed: Jul. 22, 2014

(30) Foreign Application Priority Data
Aug. 9, 2013 (JP) 2013-166617

(51) Int. Cl. G06F 17/30

(52) U.S. Cl. CPC G06F 17/30309; G06F 17/30371
USPC 707/695

(57) ABSTRACT

A non-transitory, computer-readable recording medium stores a managing program that causes a computer to execute a process including updating, in response to an update of a disk image of an information processing apparatus, a template stored in a memory unit and defining system configuration of a system that includes the information processing apparatus; and correlating the template with a reference privilege set based on an update status of the template in response to a reception of an arrangement request and saving the correlated template, in response to reception of the arrangement request for arrangement of the system using the template stored in the memory unit.

### CROSS REFERENCE TO RELATED APPLICATIONS

This application is based upon and claims the benefit of priority of the prior Japanese Patent Application No. 2013-166617, filed on Aug. 9, 2013, the entire contents of which are incorporated herein by reference.

### FIELD

The embodiments discussed herein are related to a computer product, a managing apparatus, and a managing method.

### BACKGROUND

According to a conventional technique, a template of a system is generated from an image of a virtual machine and the system is built on a physical machine using the generated template. The image of the virtual machine is updated in response to an update in software introduced in the virtual machine or a change in the service environment of the system.

In view of security, system failure prevention, etc., an update in an image of a virtual machine is reflected in the template that includes the image. If the update in the image is problematic, rollback must be performed. It is therefore necessary to save differences between the pre-update template and the post-update template as history information.

For example, a computer system having a file system that manages files compiled into a hierarchical structure on a secondary memory device is known as a related technology. The computer system restores the pre-update contents of a file/directory that includes an updated block and directory information of a superior directory including the pre-update file/directory, based on a pre-update image of and the current image of the file system. Through this process, the computer system generates a snapshot depicting an image of the file system at a given point in time in the past. For example, refer to Japanese Laid-Open Patent Publication No. 2004-157958.

Nonetheless, the conventional technique is problematic in that when an update in an image is reflected manually in a template, this update reflecting work becomes increasingly burdensome as the number of templates to be managed increases, increasing the possibility of an omission in reflecting an update event.

If every update in an image is automatically reflected in a template that includes the image through an automatization setting, an unnecessary or unsuitable template may be saved as history, posing a problem in that the number of templates to be managed becomes enormous.

### SUMMARY

According to an aspect of an embodiment, a non-transitory, computer-readable recording medium stores a managing program that causes a computer to execute a process including updating, in response to an update of a disk image of an information processing apparatus, a template stored in a memory unit and defining system configuration of a system that includes the information processing apparatus; and correlating the template with a reference privilege set based on an update status of the template in response to a reception of an arrangement request and saving the correlated template, in response to reception of the arrangement request for arrangement of the system using the template stored in the memory unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a managing method according to an embodiment;

FIG. 2 is an explanatory diagram of a system configuration example of a managing system 200;

FIG. 3 is a block diagram of a hardware configuration example of a managing apparatus 101;

FIG. 4 is an explanatory diagram of an example of the contents of a template information table 400;

FIG. 5 is an explanatory diagram of an example of the contents of a template version information table 500;

FIG. 6 is an explanatory diagram of an example of the contents of an image information table 600;

FIG. 7 is an explanatory diagram of an example of the contents of an image/template information table 700;

FIG. 8 is an explanatory diagram of an example of the contents of an image/dependent group information table 800;

FIG. 9 is an explanatory diagram of an example of the contents of a system information table 900;

FIG. 10 is a block diagram of a functional configuration example of the managing apparatus 101;

FIGS. 11A, 11B, and 11C are examples of update of the tables 400, 500, and 700 at template creation;

FIG. 12 is an explanatory diagram of an example of update of the image/dependent group information table 800;

FIGS. 13A, 13B, and 13C are explanatory diagrams of examples of update of the tables 500, 700, and 800 at history saving;

FIG. 14 is an explanatory diagram of an example of update of the image information table 600 at image updating;

FIGS. 15A and 15B are explanatory diagrams of examples of update of the tables 700 and 800 at image updating;

FIG. 16 is an explanatory diagram (1) of an example of an update status screen;

FIG. 17 is an explanatory diagram (2) of an example of the update status screen;

FIG. 18 is an explanatory diagram of an example of update of the system information table 900 at system arrangement;

FIG. 19 is an explanatory diagram (1) of an example of update of the template version information table 500 at system arrangement;

FIG. 20 is an explanatory diagram (1) of an example of update of the image/template information table 700 at system arrangement;

FIG. 21 is an explanatory diagram (1) of an example of update of the image/dependent group information table 800 at system arrangement;

FIG. 22 is an explanatory diagram (2) of an example of update of the template version information table 500 at system arrangement;

FIG. 23 is an explanatory diagram (2) of an example of update of the image/template information table 700 at system arrangement;

FIG. 24 is an explanatory diagram (2) of an example of update of the image/dependent group information table 800 at system arrangement;

FIG. 25 is an explanatory diagram of an example of update of the system information table 900 at system arrangement;

FIG. 26 is an explanatory diagram of an example of update of the template version information table 500 at system arrangement;

FIG. 27 is an explanatory diagram of an example of update of the image/template information table 700 at system arrangement;

FIG. 28 is an explanatory diagram of an example of update of the image/dependent group information table 800 at system arrangement;

FIG. 29 is a sequence diagram of an example of operation of the managing system 200;

FIG. 30 is a flowchart of an example of an operation procedure executed by an administrator in a case of creating a new template T;

FIG. 31 is a flowchart of an example of a management procedure by the managing apparatus 101; and

FIG. 32 is a flowchart of an example of a deletion procedure by the managing apparatus 101.

### DESCRIPTION OF EMBODIMENTS

Embodiments of a computer product, a managing apparatus, and a managing method will be described in detail with reference to the accompanying drawings.

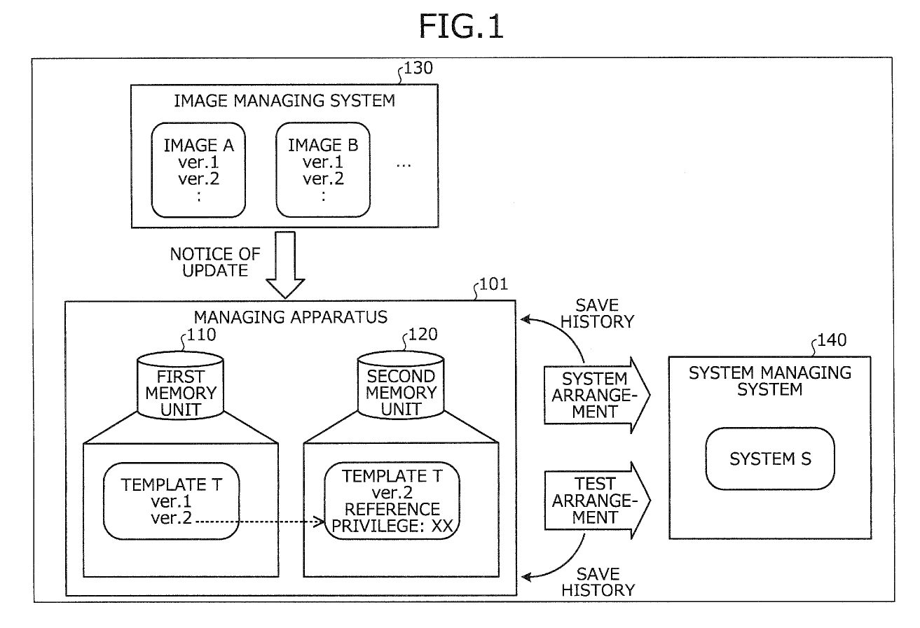

FIG. 1 is an explanatory diagram of an example of a managing method according to an embodiment. In FIG. 1, a managing apparatus 101 is a computer that manages templates T for a system. The templates T are information defining configuration of the system. Each template T defines, for example, a combination of disk images of an information processing apparatus included in the system and network configuration of the system.

The information processing apparatus is a computer in which an operating system (OS) for implementing the system is installed. The information processing apparatus may be a physical machine or may be a virtual machine running on a physical machine. A virtual machine is a virtual computer that runs in an execution environment built by dividing hardware resources of the computer.

A disk image of the information processing apparatus is an image file representing a file of an entire disk device carrying backup data of the system environment of the information processing apparatus. The disk image of the information processing apparatus includes, for example, software resource information, such as information of an OS, application software, etc., introduced in the information processing apparatus, and hardware resource information, such as information of the central processing unit (CPU) performance and input/output (I/O) performance of the information processing apparatus.

In the following description, the information processing apparatus included in the system may be expressed as “virtual machine VM”, a disk image of the information processing apparatus may be expressed as “image IM”, and a system built by using the template T may be expressed as “system S”.

The template T is created based on, for example, an image IM of the virtual machine VM. According to the template T, by cloning the image IM in the template T, an independent virtual machine VM can be made for each system S.

The image IM is updated in response to an update in software introduced in the virtual machine VM and a change in the service environment of the system S. In view of security, system failure prevention, etc., an update in the image IM has to be reflected in the template T including that image IM.

However, when an update in the image IM is reflected manually in the template T, this update reflecting work becomes increasingly burdensome as the number of templates T to be managed increases, increasing the possibility of an omission in reflecting an update event. For this reason, automatization of the update reflecting work is considered so that when the image IM is updated, the update in the image IM is reflected automatically in the template T that includes the image IM.

If an update in the image IM is problematic, rollback must be performed on the template T. It is therefore necessary to save differences between a pre-update template and a post-update template as history information. Thus, saving the differences between pre-update and post-update templates T each time an update in the image IM included in the template T occurs is considered.

However, if differences between pre-update and post-update templates T are saved each time an update in the image IM occurs, the number of templates T to be managed becomes enormous. In such a case, for example, when an administrator arranges the system S or performs rollback using the template T, the administrator has to select a template T to use among an enormous number of saved templates T, complicating management and use of the templates T.

At the update stage of the image IM, a difference in versions of software introduced in the virtual machine VM may arise. In this case, a template T may be saved that is not suitable for use in system arrangement. For example, when a mutual dependent relation exists between patch data of multiple images IM, the template T cannot be used if only some of the images IM are updated.

It is difficult for the administrator to determine which version of a template T among templates T sequentially updated automatically should be arranged, that is, to determine which template T should be arranged when an image IM is updated. This difficulty may lead to a case where the system S is arranged according to an image IM that has yet to be updated and is included in a template T and consequently the system S has a problem. For example, when communication is made between virtual machines VM in the system S, if a software version difference exists between the virtual machines VMs, a problem may occur.

However, in some cases, the system S is arranged despite the image IM included in the template T not being updated yet. One example of such cases is a case where severs (virtual machines VM) different in software version from each other are prepared in a join test in software development. In other words, templates T may include such a template T that is necessary for the administrator who conducts test arrangement of the system S and that cannot be used properly by a user who disposes the system S using the template T.

When a difference between templates T is saved, therefore, whether or not to save the template T must be determined properly based on the use status and update status of the template T. In addition, reference to and use of the template T should be controlled according to the update status of the template T.

According to this embodiment, the managing apparatus 101 updates the template T of the system S in response to an update in the image IM, and when the template T is used for arrangement of the system S, gives the template T a reference privilege corresponding to its update status and saves the template T. In this manner, templates T with arrangement records are stored in a condition where whether the templates T are disposable or not can be determined. An example of a management process by the managing apparatus 101 will hereinafter be described.

(1) According to an update in the image IM of the virtual machine VM, the managing apparatus 101 updates the template T of the system S that includes the virtual machine VM subjected to the updating process, the template T being stored in a first memory unit 110. The template T indicates a correspondence relation between the version of the template T and the version of the image IM of the virtual machine VM included in the system S.

In the example depicted in FIG. 1, the image IM of the virtual machine VM is managed by an image managing system 130. When the image managing system 130 updates the image IM, the image managing system 130 transmits to the managing apparatus 101, a notice of update of the image IM.

Upon receiving the notice of update of the image IM from the image managing system 130, the managing apparatus 101 updates the template T of the system S including the virtual machine VM subjected to the updating process. For example, the managing apparatus 101 updates the version of the updated image IM in the template T stored in the first memory unit 110.

(2) Upon receiving a request for arrangement of the system S using the template T stored in the first memory unit 110, the managing apparatus 101 sets a reference privilege for the template T, based on the update status of the template T when the request for arrangement of the system S is received. The reference privilege for the template T is a privilege enabling reference of the template T, that is, a privilege to use the template T for arrangement of the system S.

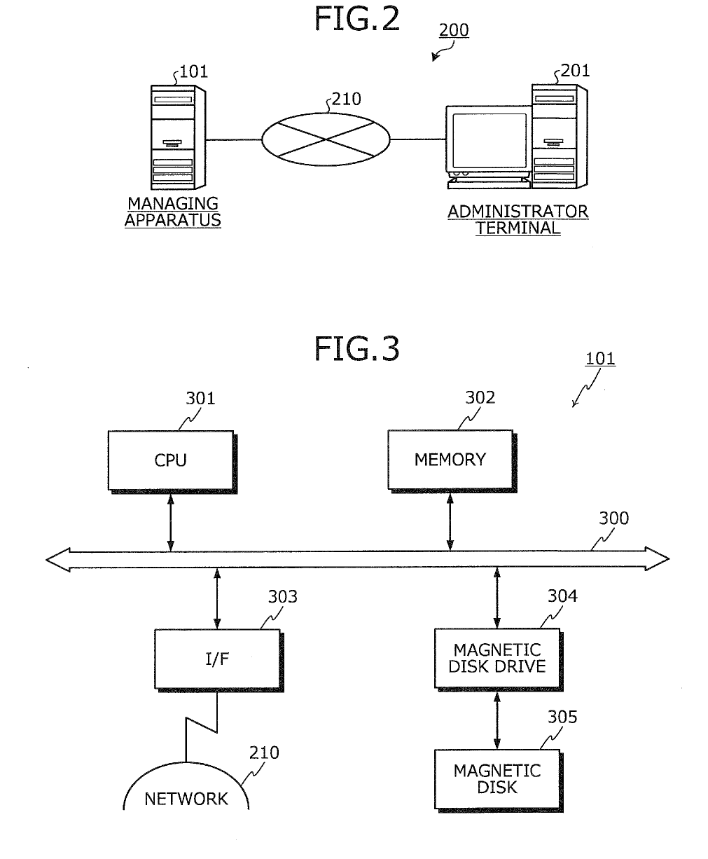

A request for arrangement of the system S is an arrangement request from a user of the system S or an arrangement request from an administrator who conducts test arrangement of the system S. The request for arrangement of the system S is issued by, for example, an input operation by the administrator using an administrator terminal (e.g., administrator terminal 201 depicted in FIG. 2).

In the example of FIG. 1, when receiving the request for disposing the system S, for example, a system managing system 140 disposes the system S using the template T. The image managing system 130 and the system managing system 140 may be systems that run on the managing apparatus 101 or may be systems that run on a computer different from the managing apparatus 101.

For example, the managing apparatus 101 sets a reference privilege for the template T based on the versions of multiple images IM having a mutual dependent relation among images IM of the virtual machine VM included in the system S. Images IM having a mutual dependent relation pose a problem in that when the images IM are of differing versions, the template T that includes the images IM is not suitable for use to actually arrange the system S.

For example, when the versions of multiple images IM having the mutual dependent relation are all the same, the managing apparatus 101 sets the reference privilege for the template T to be a reference privilege that permits the user to reference the template T. In contrast, when at least any one of the multiple images IM having the mutual dependent relation is of a different version from the rest of the images IM, the managing apparatus 101 sets the reference privilege for the template T to be a reference privilege that does not permit the user to reference the template T.

(3) The managing apparatus 101 correlates the set reference privilege for the template T with the template T at the time of reception of the request for arrangement of the system S, the template T being stored in the first memory unit 110, and saves the correlated template T. For example, the managing apparatus 101 may correlate the set reference privilege for the template T and the template T at the time of reception of the request for arrangement of the system S and save the correlated template T in a second memory unit 120.

The managing apparatus 101 may save the template T at the time of reception of the request for arrangement of the system S to the first memory unit 110, as history information and may correlate the reference privilege for the template T with the template T and save the correlated reference privilege to the second memory unit 120. In this case, the managing apparatus 101 stores the template T whose version has been updated in the first memory unit 110.

The managing apparatus 101 then sets the template T that is to be updated when the image IM is updated, to the latest version of template T among templates T stored in the first memory unit 110. As a result, in subsequent processes, the latest version of template T stored in the first memory unit 110 is recognized as the template T to be updated (compiled).

In this manner, the managing apparatus 101 updates the template T of the system S in response to an update in the image IM, and when the template T is used for arrangement of the system S, gives the template T a reference privilege that corresponds to the update status of the template, and saves the template T. Thus, templates T that have arrangement records can be stored in a state enabling determination of whether the templates T are arrangeable.

Templates T having no arrangement records can be prevented from being accumulated, as differences, at every update of the image IM, thereby suppressing increases in the number of templates T to be managed and, simplifying management and use of templates T. Whether a template T is arrangeable can be visualized based on the reference privilege given for the template T, thereby preventing a case where the system S is arranged as an image IM that has not been updated yet and thus, preventing the occurrence of a problem in the system S.

A configuration example of a managing system 200 according to the embodiment will be described.

FIG. 2 is an explanatory diagram of a system configuration example of the managing system 200. In FIG. 2, the managing system 200 includes the managing apparatus 101 and the administrator terminal 201. In the managing system 200, the managing apparatus 101 is connected to the administrator terminal 201 via a wired or radio network 210, such as a local area network (LAN), wide area network (WAN), the Internet, etc.

The managing apparatus 101 has a function of managing templates T of the system S. The managing apparatus 101 also has a function of transmitting information of an update status screen to the administrator terminal 201 in response to a request from the administrator terminal 201 to display the update status screen showing the update status of the template T. The managing apparatus 101 also has a function of arranging the system S using the template T in response to a request from the administrator terminal 201 to arrange the system S.

The administrator terminal 201 is a computer used by the administrator of the managing system 200. The administrator, for example, using the administrator terminal 201, can send to the managing apparatus 101, a request to display the update status screen showing the update status of the template T. The administrator terminal 201 can receive incoming information concerning the update status screen from the managing apparatus 101 and display the screen information. The administer, therefore, can determine the update status of the template T while viewing the update status screen, using the administrator terminal 201, and make a request to arrange the system S using the template T.

FIG. 3 is a block diagram of a hardware configuration example of the managing apparatus 101. In FIG. 3, the managing apparatus 101 includes a CPU 301, memory 302, an interface (I/F) 303, a magnetic disk drive 304, and a magnetic disk 305, respectively connected via a bus 300.

The CPU 301 performs overall control over the managing apparatus 101. The memory 302 includes, for example, read-only memory (ROM), random access memory (RAM), flash ROM, etc. For example, the flash ROM and ROM store various programs and the RAM is used as a work area of the CPU 301. A program stored in the memory 302 is loaded onto the CPU 301, which executes a process coded in the program.

The I/F 303 is connected to the network 210 through a communication line and is connected to other computers (e.g., administrator terminal 201 of FIG. 2) via the network 210. The I/F 303 administer an internal interface with the network 210, and controls the input and output of data with respect to other computers. For example, a modem, LAN adaptor, etc. may be adopted as the I/F 303.

Under the control of the CPU 301, the magnetic disk drive 304 controls the reading and writing of data with respect to the magnetic disk 305. The magnetic disk 305 stores data written thereto under the control of the magnetic disk drive 304.

In addition to the above component units, the managing apparatus 101 may also include, for example, a solid-state drive (SSD), a keyboard, a mouse, and a display. The administrator terminal 201 depicted in FIG. 2 may be implemented as a terminal having the same hardware configuration as that of the managing apparatus 101.

The contents of various tables 400, 500, 600, 700, 800, and 900 used by the managing apparatus 101 will be described. For example, the tables 400, 500, 600, 700, 800, and 900 are stored in memory devices such as the memory 302 and magnetic disk 305 of the managing apparatus 101 depicted in FIG. 3.

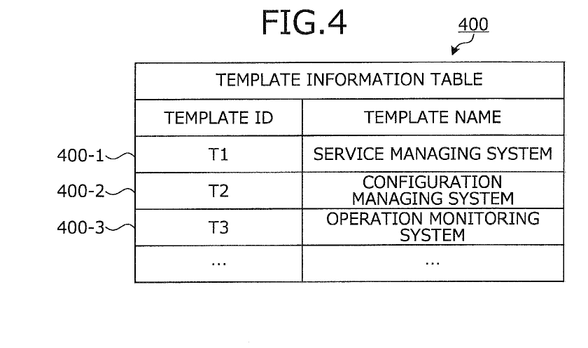

FIG. 4 is an explanatory diagram of an example of the contents of a template information table 400. In FIG. 4, the template information table 400 has fields for template ID and template name. By entering information into the fields, records of template information (e.g., template information 400-1 to 400-3) are stored.

A template ID is an identifier for identifying a template T, and a template name is the name of a template T. For example, the template information 400-1 indicates the template name “service managing system” of template T1.

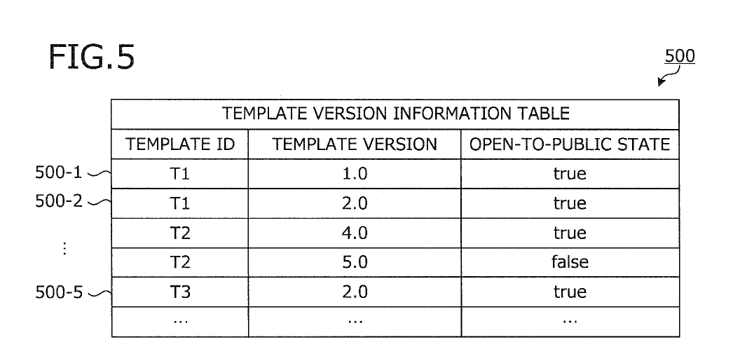

FIG. 5 is an explanatory diagram of an example of the contents of a template version information table 500. In FIG. 5, the template version information table 500 has fields for template ID, template version, and open-to-public state. By entering information into the fields, records of template version information (e.g., template version information 500-1 to 500-5) are stored.

A template ID is an identifier for identifying a template T, a template version is a version of the template T, and an open-to-public state represents a reference privilege for the template T. Open-to-public state “true” represents a reference privilege that permits the user to reference the template T, while open-to-public state “false” represents a reference privilege that does not permit the user to reference the template T.

For example, the template version information 500-1 indicates the template version “1.0” and open-to-public state “true” of the template T1 and thus, indicates that the user is permitted to reference the template T1 whose template version is “1.0”.

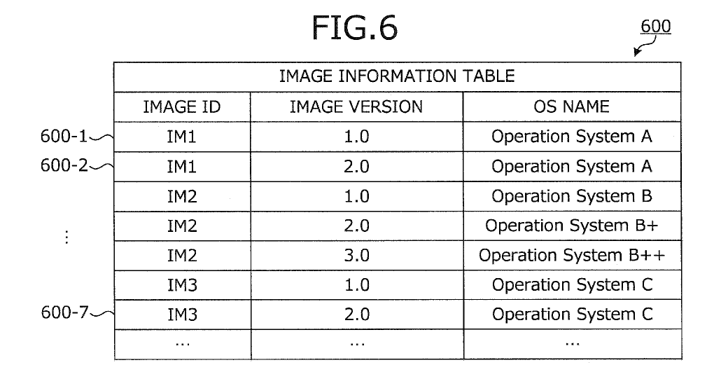

FIG. 6 is an explanatory diagram of an example of the contents of an image information table 600. In FIG. 6, the image information table 600 has fields for image ID, image version, and OS name. By entering information into the fields, records of image information (e.g., image information 600-1 to 600-7) are stored.

An image ID is an identifier for identifying an image IM, an image version is a version of the image IM, and an OS name is the name of an OS introduced in the virtual machine VM created using the image IM. For example, the image information 600-1 indicates the image version “1.0” of an image IM1 and an OS name “Operation System A”.

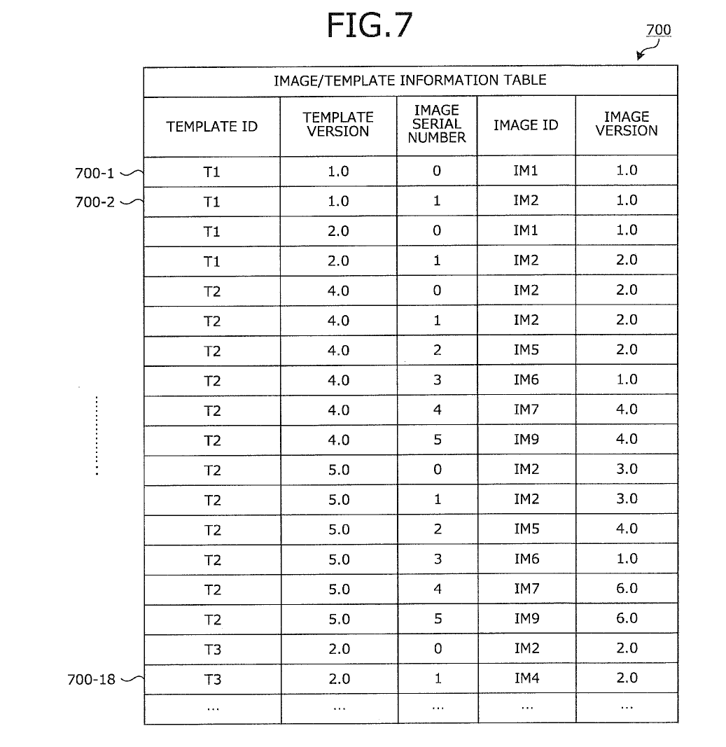

FIG. 7 is an explanatory diagram of an example of the contents of an image/template information table 700. In FIG. 7, the image/template information table 700 has fields for template ID, template version, image serial number, image ID, and image version. By entering information into the fields, records of image/template information (e.g., image/template information 700-1 to 700-18) are stored.

A template ID is an identifier for identifying a template T, a template version is a version of the template T, an image serial number is an identifier for identifying an image IM in the template T, an image ID is an identifier for identifying an image IM, and an image version is a version of the image IM.

For example, the image/template information 700-1 indicates the image M1 included in the template T1 whose template version is “1.0”, and also indicates the image serial number “0” and image version “1.0” of the image M1.

The template T1 whose template version is “1.0” is, for example, information that includes the image/template information 700-1 and 700-2. Information defining the network configuration of the system S arranged by using templates T (not depicted) is correlated with image/template information for each template T and is stored, for example, to a memory device such as the memory 302 and the magnetic disk 305.

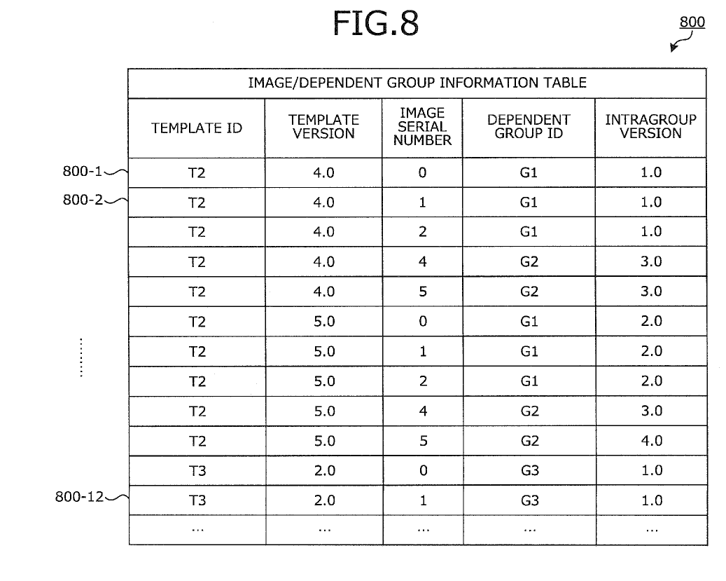

FIG. 8 is an explanatory diagram of an example of the contents of an image/dependent group information table 800. In FIG. 8, the image/dependent group information table 800 has fields for template ID, template version, image serial number, dependent group ID, and intragroup version. By entering information into the fields, records of image/dependent group information (e.g., image/dependent group information 800-1 to 800-12) are stored.

A template ID is an identifier for identifying a template T, a template version is a version of the template T, an image serial number is a number for an image IM in the template T, a dependent group ID is an identifier for identifying a group G to which multiple images IM having a mutual dependent relation belong, and an intragroup version is a version of images IM belonging to the group G, the versions being related to an update linked to the mutual dependent relation.

For example, the image/dependent group information 800-1 indicates intragroup version “1.0” for an image IM having an image serial number “0” (image IM1) and belonging to a group G1 in a template T2 whose template version is “4.0”.

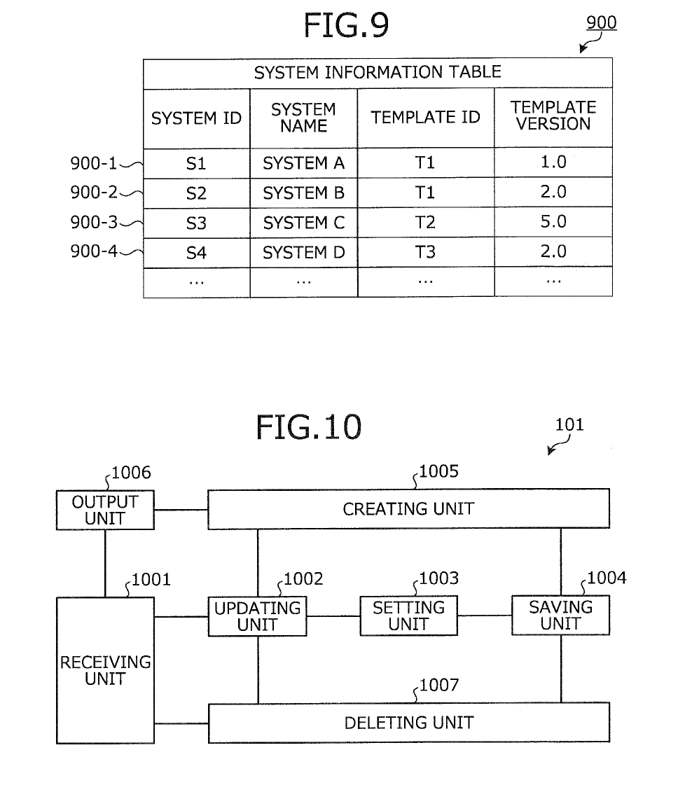

FIG. 9 is an explanatory diagram of an example of the contents of a system information table 900. In FIG. 9, the system information table 900 has fields for system ID, system name, template ID, and template version. By entering information into the fields, records of system information (e.g., system information 900-1 to 900-4) are stored.

System ID is an identifier for identifying a system S, a system name is the name of the system S, a template ID is an identifier for identifying a template T used for arranging the system S, and a template version is the version of the template T used for arranging the system S.

For example, the system information 900-1 indicates the system name “system A” for system S1 and the template ID “T1” and template version “1.0” for the template T used for arranging the system S1.

FIG. 10 is a block diagram of a functional configuration example of the managing apparatus 101. In FIG. 10, the managing apparatus 101 includes a receiving unit 1001, an updating unit 1002, a setting unit 1003, a saving unit 1004, a creating unit 1005, an output unit 1006, and a deleting unit 1007. The receiving unit 1001 to the deleting unit 1007 are functional units serving as a control unit, and are implemented by causing the CPU 301 to execute programs stored in the memory devices such as the memory 302 and magnetic disk 305 depicted in FIG. 3, or through the I/F 303. Results of processing by each functional unit are stored, for example, to memory devices such as the memory 302 and the magnetic disk 305.

The receiving unit 1001 has a function of receiving operation input by the administrator of the managing system 200. For example, the receiving unit 1001 may receive operation input by the administrator through the administrator terminal 201 or may receive operation input by the administrator who uses a keyboard or mouse (not depicted) of the managing apparatus 101 to make the operation input.

For example, the receiving unit 1001 receives a notice of an update in the image IM. The notice of the update in the image IM is information indicating that the image IM of the virtual machine VM has been subjected to an updating process. The notice of the update in the image IM includes, for example, the image ID and image version of the updated image IM and an OS name after the updating process.

The notice of the update in the image IM may include information indicating whether the update in the image IM is an update linked to a mutual dependent relation. An update linked to a mutual dependent relation means an update that affects another image IM having a mutual dependent relation with the updated image IM in the template T.

For example, the receiving unit 1001 receives a request to display the update status of the template T. The request for displaying the update status of the template T is information requesting display of the update status of the template T. The request for displaying the update status of the template T includes, for example, the template ID, template name, and template version, etc., of the template T to be displayed.

For example, the receiving unit 1001 receives a request for arrangement of the system S. A request for arrangement of the system S is an arrangement request from the user who uses the system S or an arrangement request from the administrator who conducts test arrangement of the system S. The request for arrangement of the system S includes, for example, the template ID, template name, and template version, etc., of the template T used for arrangement of the system S.

For example, the receiving unit 1001 receives a notice of an update in the system S. The notice of the update in the system S is information indicating that the system S under arrangement has been subjected to an updating process. The notice of the update in the system S includes, for example, the system ID and system name of the system S having been subjected to the updating process and the template ID and template version of the template T used for the updated system S.

The updating unit 1002 has a function such that in response to an update in the image IM of the virtual machine VM, the updating unit 1002 updates the template T that is of the system S and that includes the virtual machine VM subjected to an updating process. For example, when a notice of an update in the image IM is received, the updating unit 1002 updates the template T that includes the updated image IM.

In the following description, an image IM of a virtual machine VM subjected to an updating process may be expressed as “updated image IM”.

For example, the updating unit 1002 updates (increments) the image version of an updated image IM included in the latest version of template T in the image/template information table 700 depicted in FIG. 7. In the image/dependent group information table 800 of FIG. 8, the updating unit 1002 also updates (increments) the intragroup version of the updated image IM included in the latest version of template T.

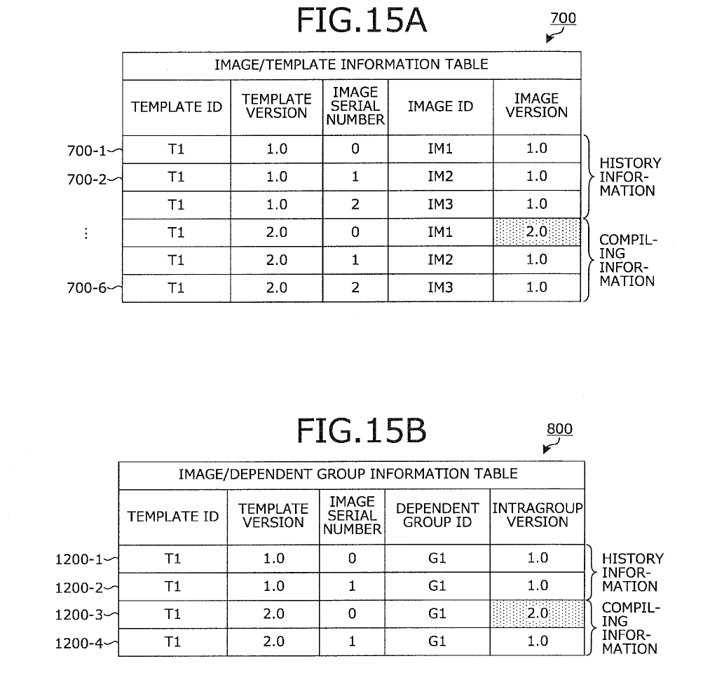

On other words, the updating unit 1002 sets the latest version of template T in each of the tables 700 and 800 to the template T for compilation and updates the image version and intragroup version of the updated image IM. Details of processing by the updating unit 1002 will be described later with reference to FIG. 15.

If the updated image IM is a result of an update not linked to a mutual dependent relation, the updating unit 1002 does not update the template T. In other words, if the updated image IM is a result of an update not linked to a mutual dependent relation, the contents of the tables 700 and 800 are not updated. Whether an update in the image IM is linked to a mutual dependent relation can be determined, for example, from a notice of an update in the image IM.

The setting unit 1003 has a function such that in response to reception of a request for arrangement of the system S using the template T, the setting unit 1003 sets a reference privilege for the template T, based on the update status of the template T at the reception of the arrangement request. For example, the setting unit 1003 refers to the image/dependent group information table 800 and determines whether all the intragroup versions of images IM belonging to the dependent group G of the template T at the reception of the request for arrangement of the system S are the same.

If all the intragroup versions are the same, the setting unit 1003 sets the reference privilege for the template T to be a reference privilege that permits the user to reference the template T. In contrast, if any one of the intragroup versions is different from the rest, the setting unit 1003 sets the reference privilege for the template T to be a reference privilege that does not permit the user to reference the template T.

The saving unit 1004 has a function of correlating a set reference privilege for the template T with the template T at the time of reception of a request for arrangement of the system S and saving the correlated template T. For example, the saving unit 1004 changes the open-to-public state of the latest version of template T in the template version information table 500 depicted in FIG. 5. This template T is the template at the time of reception of the request for arrangement of the system S.

For example, when the reference privilege on the template T is determined to be the reference privilege that permits the user to make reference to the template T, the saving unit 1004 sets the open-to-public state of the latest version of template T to “true”. In contrast, when the reference privilege for the template T is set to be a reference privilege that does not permit the user to reference the template T, the saving unit 1004 sets the open-to-public state of the latest version of template T to “false”.

Here, the saving unit 1004 saves template version information of the latest version of template T in the template version information table 500, as history information. In addition, the saving unit 1004 records new template version information created by updating (incrementing) the template version of the template T, as compiling information.

The saving unit 1004 also saves image/template information of the latest template T in the image/template information table 700, as history information. This template T is the template at the time of reception of the request for arrangement of the system S. The saving unit 1004 then updates (increments) the template version of the template T to create new template version information and records the new template version information as compiling information.

The saving unit 1004 also saves image/dependent group information of the latest version of template T in the image/dependent group information table 800, as history information. This template T is the template at the time of reception of the request for arrangement of the system S. The saving unit 1004 updates (increments) the template version of the template T to create new template version information and records the new template version information as compiling information. Details of processing by the saving unit 1004 will be described later with reference to FIGS. 19 to 24.

The creating unit 1005 has a function of creating information of an update status screen showing the update status of the template T. For example, the creating unit 1005 refers to the image/dependent group information table 800 and creates the information of the update status screen showing the update status of the template T, based on the intragroup versions of the images IM belonging to the dependent group G of the template T.

The output unit 1006 has a function of outputting created information of the update status screen showing the update status of the template T. The output unit 1006 outputs the screen information by, for example, displaying the information on a display (not depicted), printing out the information at a printer (not depicted), or transmitting the information to another computer through the I/F 303.

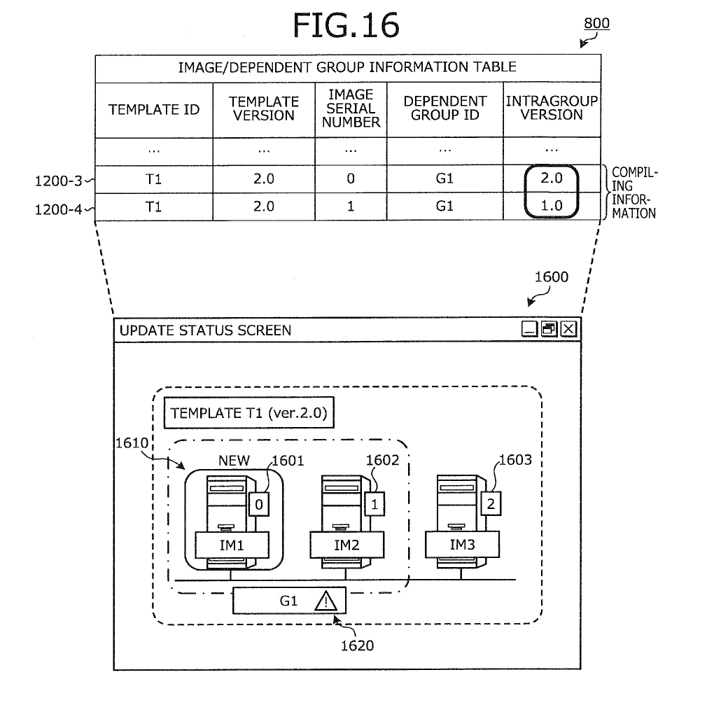

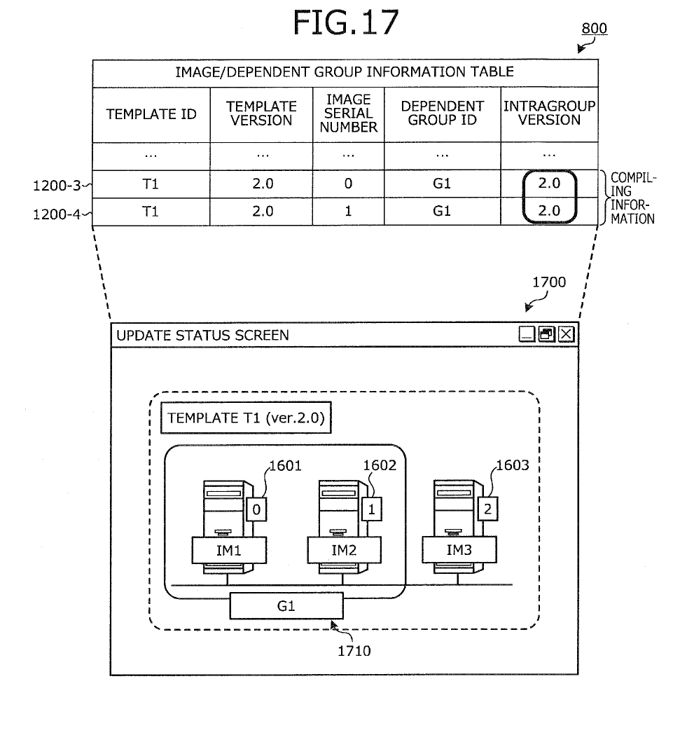

For example, responding to reception of a request from the administrator terminal 201 to display the update status of the template T, the output unit 1006 transmits the information of the update status screen showing the update status of the template T to the administrator terminal 201. As a result, the update status screen is displayed on the display (not depicted) of the administrator terminal 201. An example of the update status screen will be described later with reference to FIGS. 16 and 17.

The deleting unit 1007 has a function of deleting among templates T recorded in the image/template information table 700, a template T recorded before the template T recorded immediately before the recording of a template T used for arrangement of the system S under arrangement. The template version of the template T as a deletion candidate is assumed to be “x”.

In this case, for example, responding to reception of a notice of an update in the system S, the deleting unit 1007 refers to the system information table 900 depicted in FIG. 9 and determines whether a system S arranged using a template T whose template version is older than “x+1” is present.

If a system S arranged using a template T whose template version is older than “x+1” is not present, the deleting unit 1007 deletes the template T whose template version is “x”. This means that the deleting unit 1007 deletes the template T two-generations older in version than the template T used for arrangement of the system S under arrangement because use of the older template T in a rollback process, etc., is highly unlikely.

In contrast, if a system S arranged using a template T whose template version is older than “x+1” is present, the deleting unit 1007 does not delete the template T whose template version is “x” because the template T may possibly be used in a rollback process, etc. Details of processing by the deleting unit 1007 will be described later with reference to FIGS. 26 to 28.

Examples of update of the tables 400, 500, 600, 700, 800, and 900 used by the managing apparatus 101 will be described.

An example of update of the tables 400, 500, and 700 in a case where a new template T has been created based on the image IM of the virtual machine VM will be described. A case is assumed where the template T1 with the template name “service managing system” is newly created through operation input by the administrator.

The administrator may access the managing apparatus 101 from the administrator terminal 201 and make various operation inputs, or may make various operation inputs using the keyboard or mouse (not depicted) of the managing apparatus 101. In the following description, the template T whose template version is “x” may be expressed as “template T (ver. x)”.

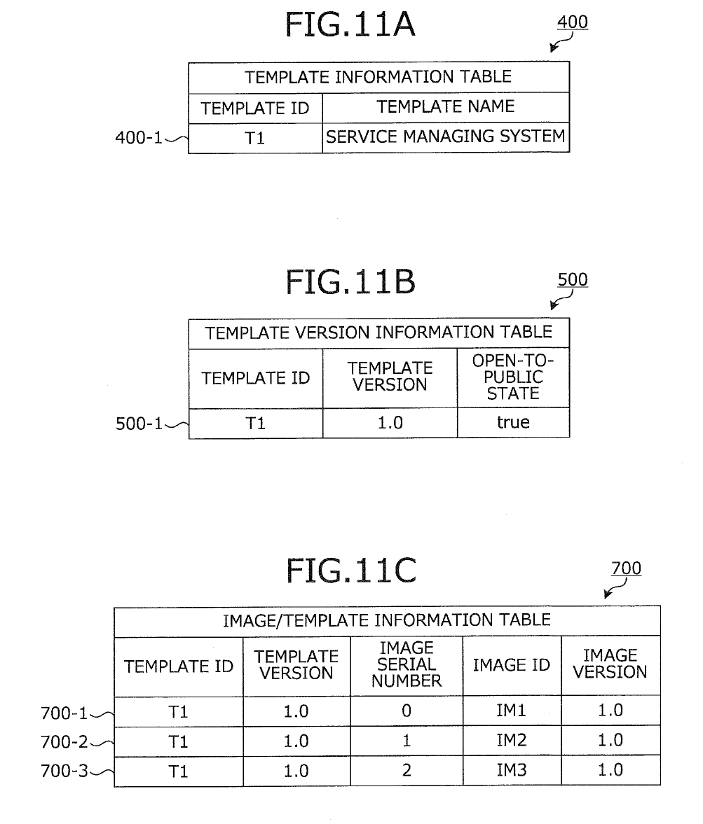

FIGS. 11A, 11B, and 11C are examples of update of the tables 400, 500, and 700 at template creation. As depicted in FIG. 11A, when the template T1 of the template name “service managing system” is newly created, a record of the template information 400-1 is entered into the template information table 400 through operation input by the administrator.

As depicted in FIG. 11B, through operation input by the administrator, a record of the template version information 500-1 is entered into the template version information table 500. As depicted in FIG. 11C, through operation input by the administrator, records of the image/template information 700-1 to 700-3 are entered into the image/template information table 700.

An example of update of the image/dependent group information table 800 in a case where a mutual dependent relation between images IM in the template T1 (ver. 1.0) is set will be described.

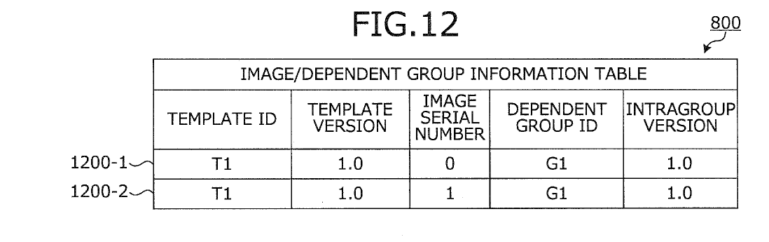

FIG. 12 is an explanatory diagram of an example of update of the image/dependent group information table 800. As depicted in FIG. 12, when a mutual dependent relation exists between images IM in the template T1 (ver. 1.0), records of the image/dependent group information 1200-1 and 1200-2 are entered into the image/dependent group information table 800 through operation input by the administrator.

The image/dependent group information 1200-1 and 1200-2 indicate that images IM1 and IM2 in the template T1 (ver. 1.0) belong to the dependent group G1 and that a mutual dependent relation exists between the images IM1 and IM2.

An example of update of the tables 500, 700, and 800 in a case where the template T1 (ver. 1.0) is saved as history will be described.

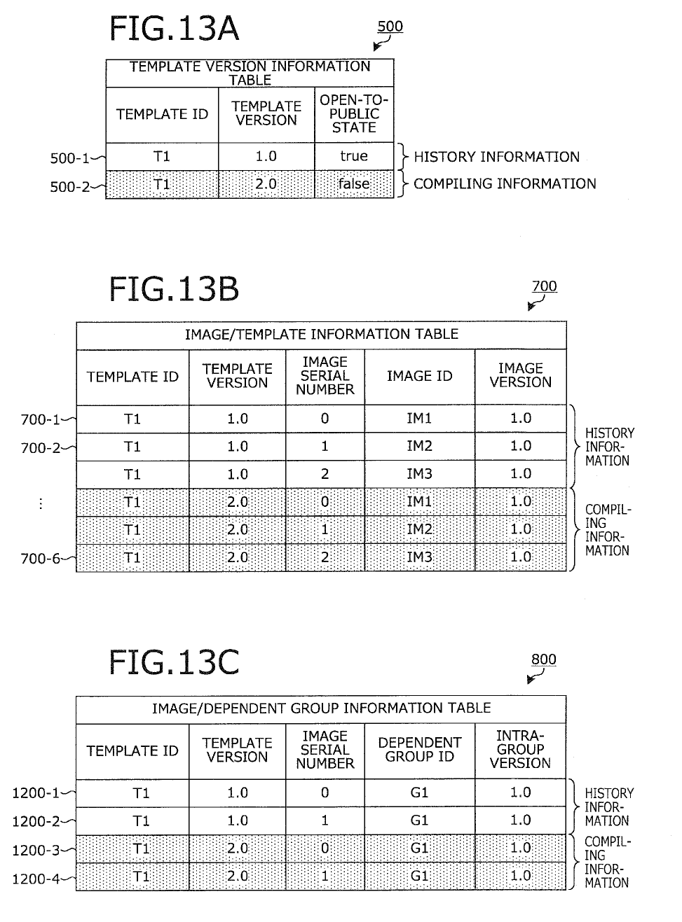

FIGS. 13A, 13B, and 13C are explanatory diagrams of examples of update of the tables 500, 700, and 800 at history saving. As depicted in FIG. 13A, when the template T1 (ver. 1.0) is saved as a history, in the template version information table 500, the template version information 500-1 is saved as history information and the template version information 500-2 is recorded as compiling information, through operation input by the administrator.

As depicted in FIG. 13B, through operation input by the administrator, in the image/template information table 700, the image/template information 700-1 to 700-3 is saved as history information and the image/template information 700-4 to 700-6 is recorded as compiling information. As depicted in FIG. 13C, through operation input by the administrator, in the image/dependent group information table 800, the image/dependent group information 1200-1 and 1200-2 is saved as history information and the image/dependent group information 1200-3 and 1200-4 is recorded as compiling information.

An example of update of the tables 600, 700, and 800 in a case where the image IM1 of the virtual machine VM1 has been updated will be described. In the following description, the image IM whose image version is “y” may be expressed as “image IM (ver. y)”.

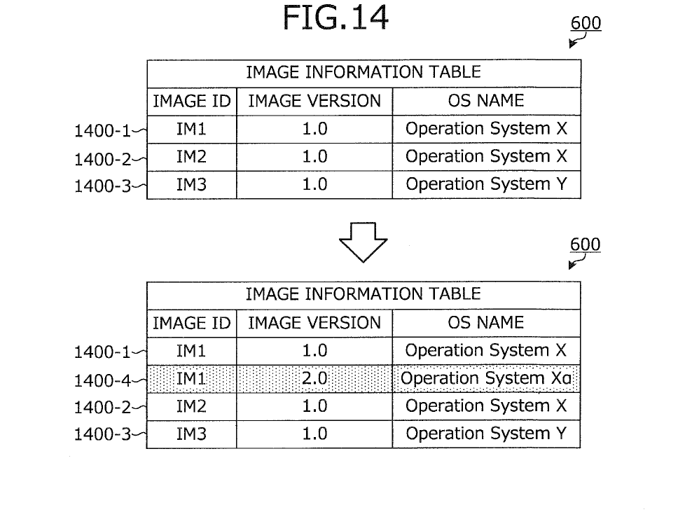

FIG. 14 is an explanatory diagram of an example of update of the image information table 600 at image updating. In FIG. 14, records of image information 1400-1 to 1400-3 are stored in the image information table 600. When the image IM1 (ver. 1.0) is updated, a record of image information 1400-4 is stored in the image information table 600 through operation input by the administrator. The image information 1400-4 indicates the image version “2.0” and OS name “Operation System Xα” of the image IM1.

FIGS. 15A and 15B are explanatory diagrams of examples of update of the tables 700 and 800 at image updating. As depicted in FIG. 15A, when the image IM1 (ver. 1.0) is updated, the updating unit 1002 changes the image version of image/template information 700-4 (compiling information) in the image/template information table 700, to “2.0”. As depicted in FIG. 15B, the updating unit 1002 also changes the intragroup version of image/dependent group information 1200-3 in the image/dependent group information table 800, to “2.0”.

An example of the update status screen showing the update status of the template T at image updating will be described. The update status screen is displayed, for example, on the display (not depicted) of the administrator terminal 201.

FIG. 16 is an explanatory diagram (1) of an example of the update status screen. In FIG. 16, an update status screen 1600 shows the update status of the template T1 (ver. 2.0). The update status screen 1600 is an example of the update status screen based on the image/dependent group information 1200-3 and 1200-4 in the image/dependent group information table 800 of FIG. 16.

For example, images IM1, IM2, and IM3 included in the template T1 (ver. 2.0) are displayed on the update status screen 1600. Reference numerals 1601 to 1603 indicate image serial numbers in the template T1 (ver. 2.0). The image IM1 is highlighted by an icon 1610 indicating that the image IM1 has been updated. Because the images IM1 and IM2 belonging to the dependent group G1 differ in intragroup version, the dependent group G1 is highlighted by an icon 1620 indicating that the images IM1 and IM2 are not suitable (NG) for system arrangement.

Based on the update status screen 1600, for example, the administrator determines that the images IM1 and IM2 having a mutual dependent relation differ in intragroup version and therefore, does not permit the user to reference the template T1 (ver. 2.0)

An example of the update status screen showing the update status of the template T1 (ver. 2.0) in a case where the image IM2 of the virtual machine VM2 has been updated will be described.

FIG. 17 is an explanatory diagram (2) of an example of the update status screen. In FIG. 17, an update status screen 1700 shows the update status of the template T1 (ver. 2.0). The update status screen 1700 is an example of the update status screen based on the image/dependent group information 1200-3 and 1200-4 in the image/dependent group information table 800 depicted in FIG. 17.

For example, images IM1, IM2, and IM3 included in the template T1 (ver. 2.0) are displayed on the update status screen 1700. As a result of an update in the image IM2, the icons 1610 and 1620 displayed on the screen of FIG. 16 are not displayed on the update status screen 1700. Because the intragroup versions of the images IM1 and IM2 belonging to the dependent group G1 have become identical, the dependent group G1 is highlighted with an icon 1710 indicating that the dependent group G1 is suitable for system arrangement.

Based on the update status screen 1700, for example, the administrator determines that the intragroup versions of the images IM1 and IM2 having a mutual dependent relation are identical and therefore, permits the user to reference the template T1 (ver. 2.0)

An example of update of the tables 500, 700, 800, and 900 in a case where the system S is arranged using the template T will be described. A case where the system S is arranged when a dependent group G not suitable for system arrangement is not present in the template T will be described.

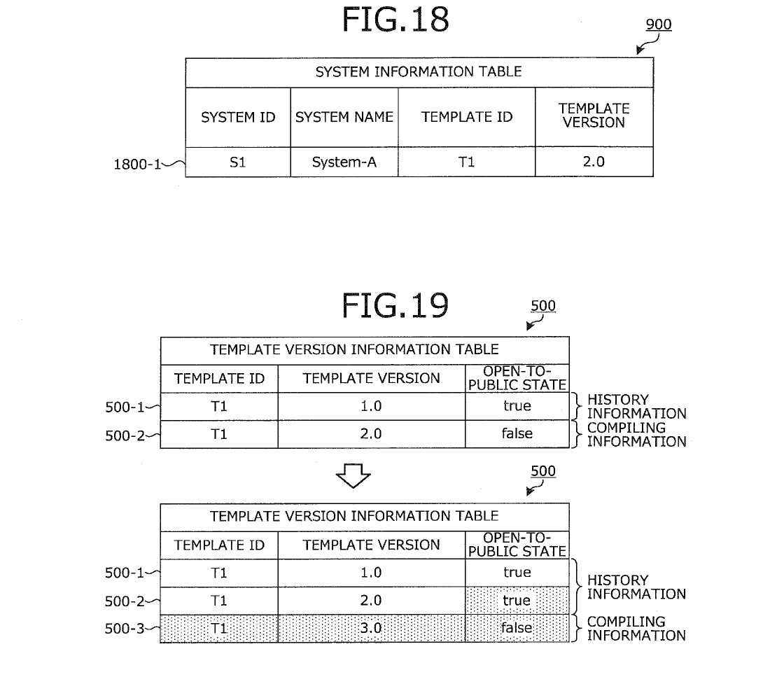

FIG. 18 is an explanatory diagram of an example of update of the system information table 900 at system arrangement. As depicted in FIG. 18, when a system S1 is arranged using the template T1 (ver. 2.0), the managing apparatus 101 stores a record of system information 1800-1 in the system information table 900.

FIG. 19 is an explanatory diagram (1) of an example of update of the template version information table 500 at system arrangement. In FIG. 19, records of template version information 500-1 and 500-2 are stored in the template version information table 500.

When the system S1 is arranged using the template T1 (ver. 2.0), the saving unit 1004 changes the open-to-public state of the template version information 500-2 (compiling information) in the template version information table 500, to “true” and sets the template version information 500-2 to history information.

The saving unit 1004 records template version information 500-3 into the template version information table 500, as compiling information. The template version information 500-3 indicates the template version “3.0” and open-to-public state “false” of the template T1.

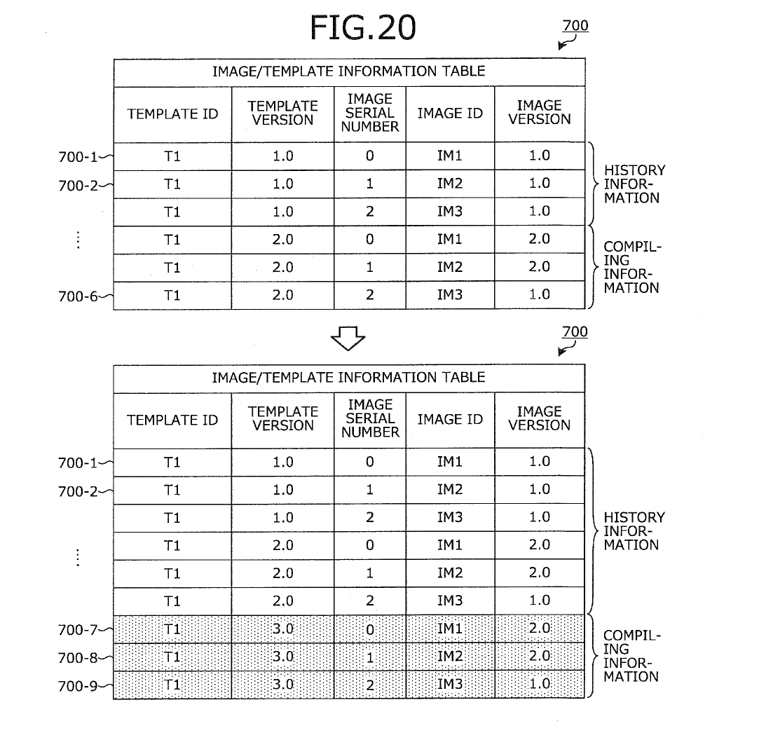

FIG. 20 is an explanatory diagram (1) of an example of update of the image/template information table 700 at system arrangement. In FIG. 20, records of image/template information 700-1 to 700-6 are stored in the image/template information table 700.

When the system S1 is arranged using the template T1 (ver. 2.0), the saving unit 1004 sets the image/template information 700-4 to 700-6 in the image/template information table 700, to history information.

The saving unit 1004 records image/template information 700-7 to 700-9 into the image/template information table 700, as compiling information. The image/template information 700-7 to 700-9 indicates the template T1 (ver. “3.0”).

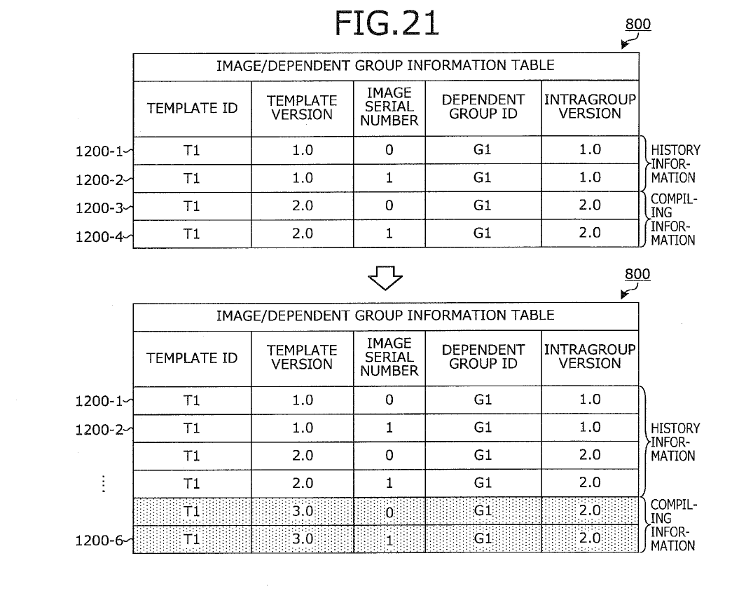

FIG. 21 is an explanatory diagram (1) of an example of update of the image/dependent group information table 800 at system arrangement. In FIG. 21, records of image/dependent group information 1200-1 to 1200-4 are stored in the image/dependent group information table 800.

When the system S1 is arranged using the template T1 (ver. 2.0), the saving unit 1004 sets the image/dependent group information 1200-3 and 1200-4 in the image/dependent group information table 800, to history information.

The saving unit 1004 records image/dependent group information 1200-5 and 1200-6 into the image/dependent group information table 800, as compiling information. The image/dependent group information 1200-5 and 1200-6 indicates the intragroup versions of the images M1 and MT2 belonging to the dependent group G1 in the template T1 (ver. “3.0”).

A case where the system S is arranged when a dependent group G not suitable for system arrangement is present in the template T will be described.

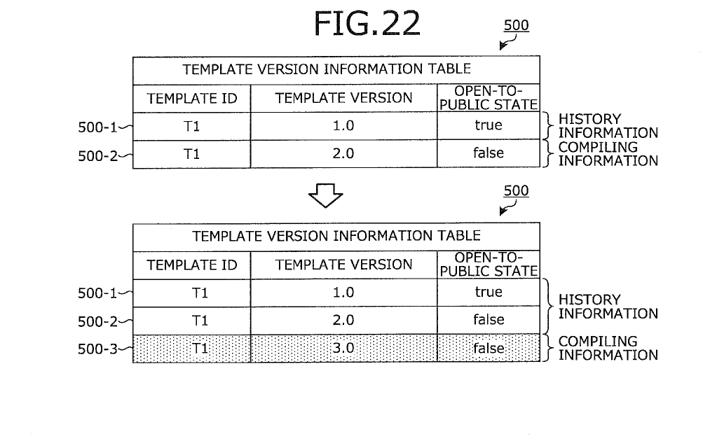

FIG. 22 is an explanatory diagram (2) of an example of update of the template version information table 500 at system arrangement. In FIG. 22, records of template version information 500-1 and 500-2 are stored in the template version information table 500.

When the system S1 is arranged using the template T1 (ver. 2.0), the saving unit 1004 sets the template version information 500-2 in the template version information table 500, to history information and records template version information 500-3 into the template version information table 500, as compiling information.

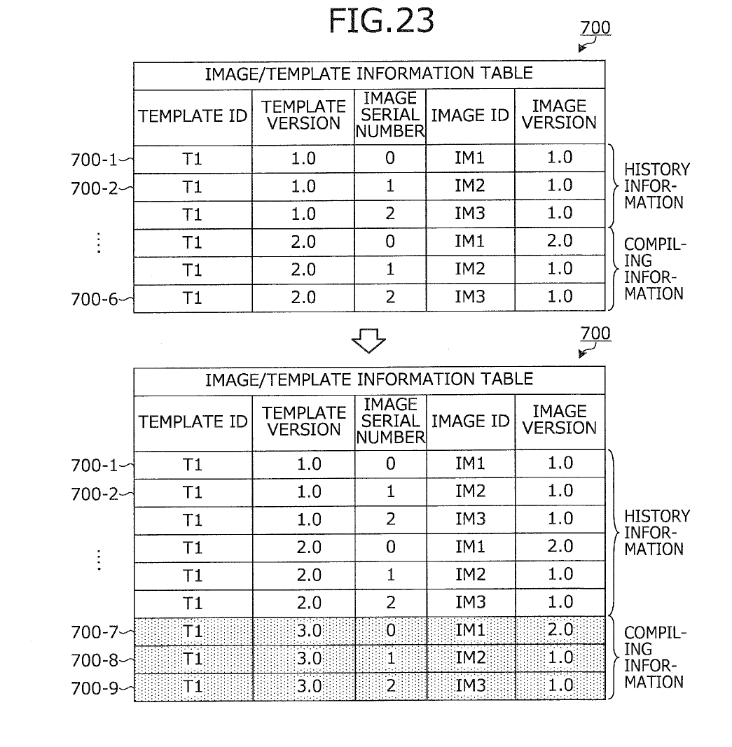

FIG. 23 is an explanatory diagram (2) of an example of update of the image/template information table 700 at system arrangement. In FIG. 23, records of image/template information 700-1 to 700-6 are stored in the image/template information table 700.

When the system S1 is arranged using the template T1 (ver. 2.0), the saving unit 1004 sets the image/template information 700-4 to 700-6 in the image/template information table 700, to history information. The saving unit 1004 records image/template information 700-7 to 700-9 into the image/template information table 700, as compiling information.

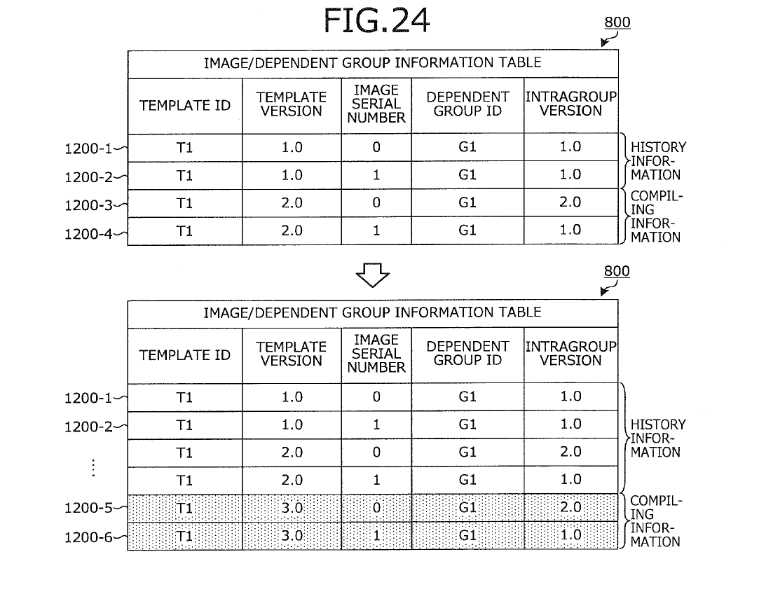

FIG. 24 is an explanatory diagram (2) of an example of update of the image/dependent group information table 800 at system arrangement. In FIG. 24, records of image/dependent group information 1200-1 to 1200-4 are stored in the image/dependent group information table 800.

When the system S1 is arranged using the template T1 (ver. 2.0), the saving unit 1004 sets the image/dependent group information 1200-3 and 1200-4 in the image/dependent group information table 800, to history information. The saving unit 1004 records image/dependent group information 1200-5 and 1200-6 into the image/dependent group information table 800, as compiling information.

An example of update of various tables in a case where the system S1 arranged using the template T1 (ver. 2.0) has been updated will be described on the assumption that no system S arranged using the template T1 whose template version is older than the template version “2.0” is present, except the system S1.

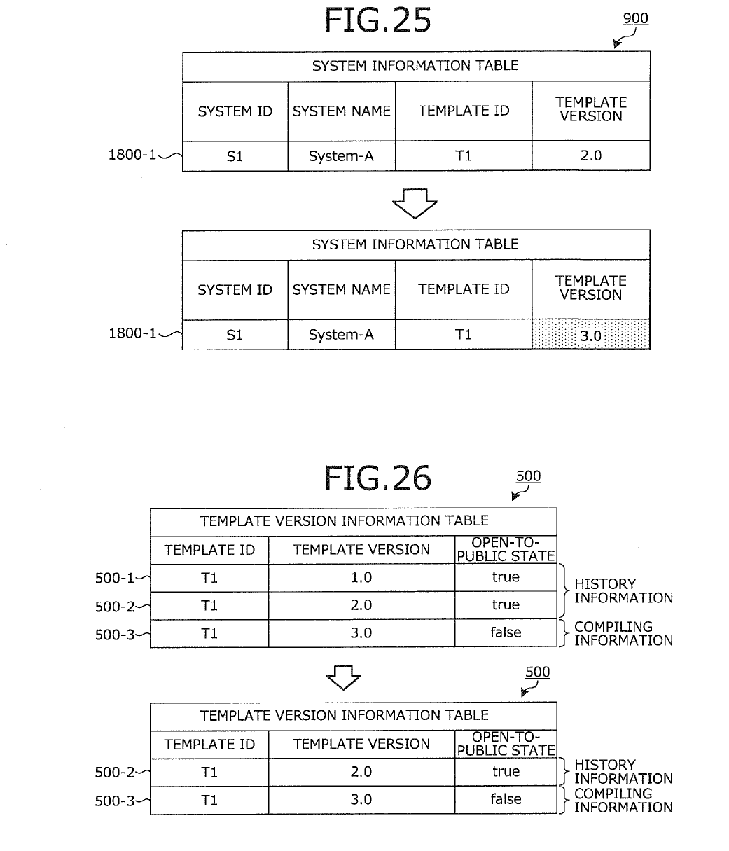

FIG. 25 is an explanatory diagram of an example of update of the system information table 900 at system arrangement. A case is assumed where a difference between the template T1 (ver. 2.0) and the template T1 (ver. 3.0), that is, patch data to be applied to the image IM is taken into the system S1 arranged using the template T1 (ver. 2.0). In this case, the managing apparatus 101 changes the template version of the system information 1800-1 in the system information table 900, to “3.0”.

FIG. 26 is an explanatory diagram of an example of update of the template version information table 500 at system arrangement. When the system S1, which has been arranged using the template T1 (ver. 2.0) and is under arrangement, is updated, the deleting unit 1007 deletes the template version information 500-1 (history information) from the template version information table 500.

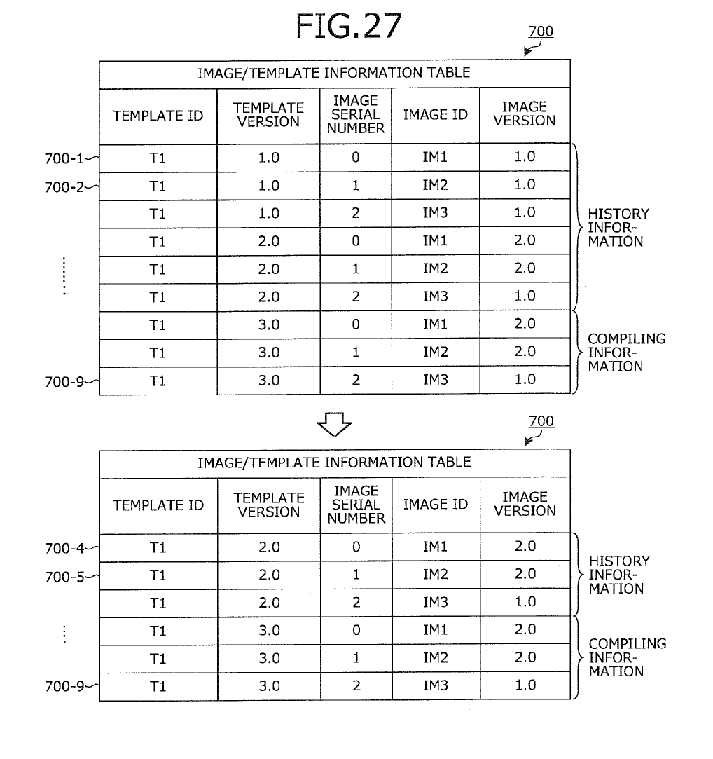

FIG. 27 is an explanatory diagram of an example of update of the image/template information table 700 at system arrangement. When the system S1, which has been arranged using the template T1 (ver. 2.0) and is under arrangement, is updated, the deleting unit 1007 deletes the image/template information 700-1 to 700-3 (history information) from the image/template information table 700.

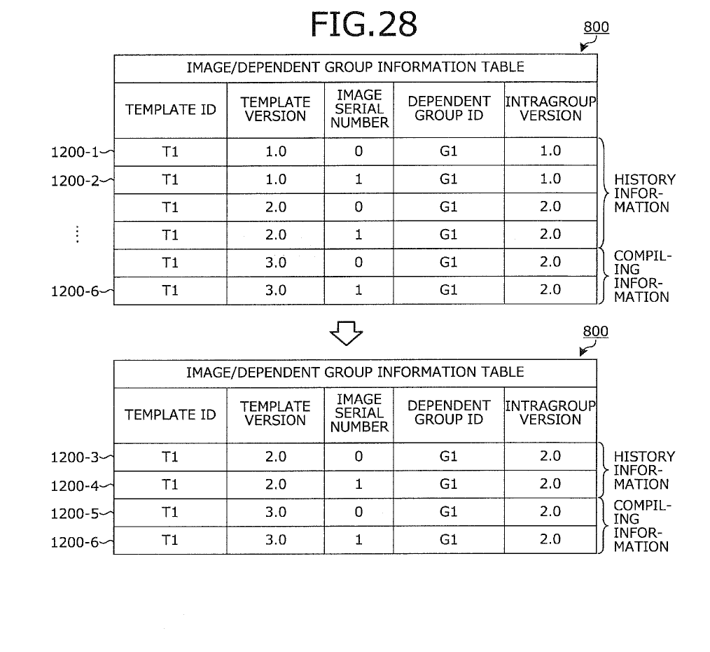

FIG. 28 is an explanatory diagram of an example of update of the image/dependent group information table 800 at system arrangement. When the system S1, which has been arranged using the template T1 (ver. 2.0) and is under arrangement, is updated, the deleting unit 1007 deletes the image/dependent group information 1200-1 to 1200-2 (history information) from the image/dependent group information table 800.

In this manner, the template T (ver. 1.0) two-generations older in version than the template T (ver. 3.0) used for arrangement of the system S1 under arrangement is deleted because the template T (ver. 1.0) is unlikely to be used in a rollback process, etc. Thus, increases in memory consumption by the managing apparatus 101 consequent to version upgrades of the template T can be suppressed.

An example of operation of the managing system 200 in a case where the image IM of the virtual machine VM has been updated will be described.

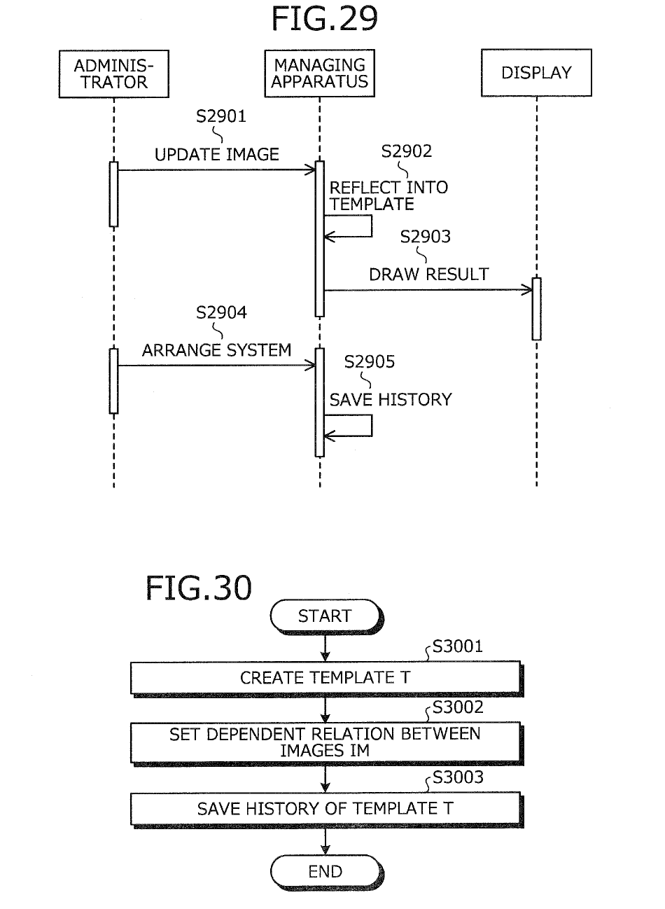

FIG. 29 is a sequence diagram of an example of operation of the managing system 200. In FIG. 29, the administrator updates the image IM of the virtual machine VM (step S2901). The managing apparatus 101 reflects the update of the image IM into the template T (step S2902).

The managing apparatus 101 draws the result of update of the template T on the display (step S2903). Referring to the result of update of the template T, the administrator arranges the system S using the template T (step S2904). The administrator then saves a history of the template T used for arrangement of the system S (step S2905).

A detailed operation procedure by the managing system 200 will hereinafter be described with reference to FIGS. 30 to 32. An operation procedure executed by the administrator in a case of creating a new template T will be described first.

FIG. 30 is a flowchart of an example of an operation procedure executed by the administrator in a case of creating a new template T. In the flowchart depicted in FIG. 30, the administrator first refers to the image information table 600 and creates the template T, based on the image IM of the virtual machine VM (step S3001). For example, as depicted in FIG. 11, the contents of the tables 400, 500, and 700 are updated.

The administrator then sets a mutual dependent relation between images IM in the created template T (step S3002). For example, as depicted in FIG. 12, the contents of the image/dependent group information table 800 are updated.

The administrator then saves a history of the created template T (step S3003) and ends a series of operations in the flowchart. For example, as depicted in FIG. 13, the contents of the tables 500, 700, and 800 are updated. Thus, the new template T is recorded in the tables.

A management procedure performed by the managing apparatus 101 when the image IM of the virtual machine VM has been updated through operation input by the administrator will be described.

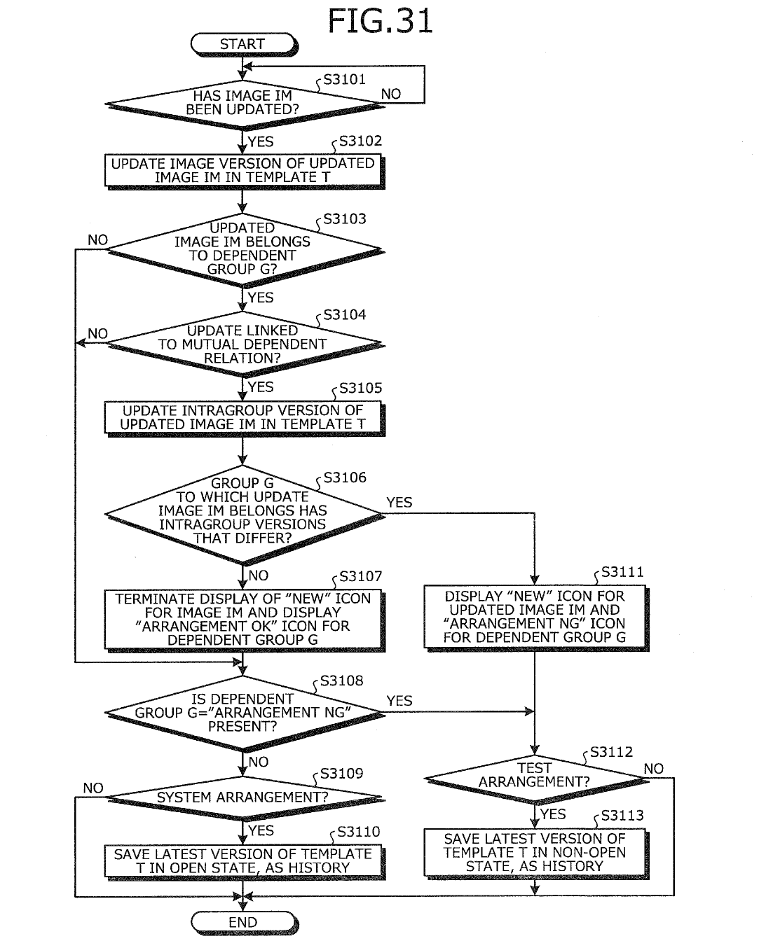

FIG. 31 is a flowchart of an example of the management procedure by the managing apparatus 101. In the flowchart depicted in FIG. 31, the managing apparatus 101 determines whether an image IM of the virtual machine VM has been updated (step S3101). The managing apparatus 101 stands by until an image IM is updated (step S3101: NO).

When an image IM has been updated (step S3101: YES), the managing apparatus 101 updates the image version of the updated image IM in the latest version of template T (compiling information) stored in the image/template information table 700 (step S3102).

The managing apparatus 101 refers to the image/dependent group information table 800 and determines whether the updated image IM belongs to the dependent group G (step S3103). If the updated image IM does not belong to the dependent group G (step S3103: NO), the managing apparatus 101 proceeds to step S3108.

If the updated image IM belongs to the dependent group G (step S3103: YES), the managing apparatus 101 determines whether the update performed to create the updated image IM is linked to a mutual dependent relation (step S3104). If the update performed to create the updated image IM is not linked to a mutual dependent relation (step S3104: NO), the managing apparatus 101 proceeds to step S3108.

If the update performed to create the updated image IM is linked to a mutual dependent relation (step S3104: YES), the managing apparatus 101 updates the intragroup version of the updated image IM in the latest version of template T (compiling information) stored in the image/dependent group information table 800 (step S3105).

The managing apparatus 101 then refers to the image/dependent group information table 800 and determines whether the group G to which the update image IM belongs has intragroup versions that differ from one another (step S3106).

If the group G does not have intragroup versions that differ from on another (step S3106: NO), the managing apparatus 101 deletes from an update status screen showing the update status of the template T, a NEW icon of the image IM in the dependent group G and displays an ARRANGEMENT OK icon for the dependent group G on the screen (step S3107).

The NEW icon is, for example, the icon 1610 of FIG. 16, and the ARRANGEMENT OK icon is the icon 1710 of FIG. 17.

The managing apparatus 101 then refers to the image/dependent group information table 800 and determines whether a dependent group G not suitable for system arrangement is present in the template T (step S3108). A dependent group G not suitable for system arrangement is the group G having intragroup versions that differ from one another.

If a dependent group G not suitable for system arrangement is present (step S3108: YES), the managing apparatus 101 proceeds to step S3112. If a dependent group G not suitable for system arrangement is not present (step S3108: NO), the managing apparatus 101 determines whether a request for arrangement of the system S using the template T has been received (step S3109).

Upon receiving a request for arrangement of the system S using the template T (step S3109: YES), the managing apparatus 101 saves the latest version of template T in a state of open to the user, as a history (step S3110), and ends a series of operations of the flowchart. For example, as depicted in FIGS. 19 to 21, the contents of the tables 500, 700, and 800 are updated.

If no request for arrangement of the system S is received (step S3109: NO), the managing apparatus 101 ends a series of operations of the flowchart.

If the group G has intragroup versions that differ from one another at step S3106, (step S3106: YES), the managing apparatus 101 displays a NEW icon for the updated image IM in the dependent group G on the update status screen showing the update status of the template T and displays an ARRANGEMENT NG icon for the dependent group G on the screen (step S3111).

The managing apparatus 101 then determines whether a request for test arrangement of the system S using the template T has been received (step S3112).

Upon receiving a request for test arrangement of the system S using the template T (step S3112: YES), the managing apparatus 101 saves the latest version of template T in a state of non-open to the user, as a history (step S3113), and ends a series of operations of the flowchart. For example, as depicted in FIGS. 22 to 24, the contents of the tables 500, 700, and 800 are updated.

If no request for test arrangement of the system S is received (step S3112: NO), the managing apparatus 101 ends a series of operations of the flowchart.

In this manner, the template T of the system S is updated in response to an update in the image IM, and when the template T is used for arrangement of the system S, the template T is saved with a reference privilege given therefor as a reference privilege corresponding to the update status.

A deletion procedure performed by the managing apparatus 101 when the system S in arrangement has been updated will be described.

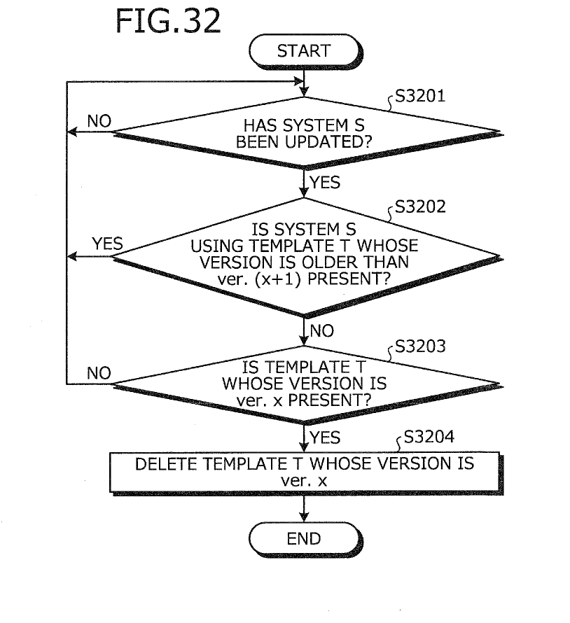

FIG. 32 is a flowchart of an example of the deletion procedure by the managing apparatus 101. In the flowchart of FIG. 32, the managing apparatus 101 first determines whether the system S under arrangement has been updated (step S3201). The managing apparatus 101 stands by until the system S under arrangement is updated (step S3201: NO).

When the system S under arrangement has been updated (step S3201: YES), the managing apparatus 101 determines whether a system S using a template T whose version is older than ver. (x+1) is present (step S3202). If a system S using a template T whose version is older than ver. (x+1) is present (step S3202: YES), the managing apparatus 101 returns to step S3201.

If a system S using the template T whose version is older than ver. (x+1) is not present (step S3202: NO), the managing apparatus 101 refers to the template version information table 500 and determines whether a template T whose version is ver. x is present (step S3203). If a template T whose version is ver. x is not present (step S3203: NO), the managing apparatus 101 returns to step S3201.

If a template T whose version is ver. x is present (step S3203: YES), the managing apparatus 101 deletes the template T whose version is ver. x (step S3204), and ends a series of operations of the flowchart. For example, as depicted in FIGS. 26 to 28, the contents of the tables 500, 700, and 800 are updated.

In this manner, a template T two-generations older in version than the template T used for arrangement of the system S in arrangement can be deleted.

As described above, according to the managing apparatus 101 of the embodiment, in response to an update in the image IM, the template T of the system S that includes the virtual machine VM subjected to an updating process can be updated. This automates reflection of updated contents in the template T when the image IM is updated, thereby reducing the work load resulting from reflection of updated contents in the template T and preventing omissions in the reflection work.

According to the managing apparatus 101, in response to reception of a request for arrangement of the system S using the template T, a reference privilege for the template T can be set based on the update status of the template T at the time of reception of the arrangement request. According to the managing apparatus 101, the template T at the time of reception of the arrangement request can be saved as the template T correlated with the reference privilege set for the template T.

In this manner, the template T used for arrangement of the system S can be saved selectively with a reference privilege given to the template T as a reference privilege corresponding to the update status. For example, in response to a request for arrangement of the system S, the template T at the time of reception of the arrangement request can be saved. Thus, templates T with no arrangement record can be prevented from being accumulated, thereby suppressing increases in memory consumption.

According to the managing apparatus 101, a reference privilege for the template T can be set based on the image versions of multiple images IM having a mutual dependent relation and included in the template T at the time of reception of an arrangement request. As a result, a template T that is highly likely to cause a problem when used for arrangement of the system S can be identified.

According to the managing apparatus 101, information of an update status screen showing the update status of the template T can be created based on the image versions of multiple images IM having a mutual dependent relation and included in the template T. According to the managing apparatus 101, the created information of the update status screen can be output in response to reception of a request for displaying the update status screen.

As a result, a difference between images IM having a mutual dependent relation in the template T can be visualized. The administrator can easily determine the possibility of arrangement of the system S using the template T or the timing of test arrangement by checking the update status screen.

According to the managing apparatus 101, a template T two-generations older in version than the template T used for arrangement of the system under arrangement can be deleted. Thus, a template T unlikely to be used for a rollback process, etc. can be deleted, whereby increases in memory consumption resulting from the version upgrade of the template T can be suppressed.

Consequently, according to the managing apparatus 101, templates T having arrangement records can be stored in a state enabling determination of whether the templates T are arrangeable. Consequently, an accumulation of unnecessary templates T having no arrangement record created during the course of system development can be prevented, simplifying management and use of templates T.

The managing method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing a managing program that causes a computer to execute a process comprising:
updating, in response to an update of a disk image of an information processing apparatus, a template stored in a memory unit and defining system configuration of a system that includes the information processing apparatus; and
correlating the template with a reference privilege set based on an update status of the template in response to a reception of an arrangement request and saving the correlated template, in response to reception of the arrangement request for arrangement of the system using the template stored in the memory unit.

2. The managing program according to claim 1, wherein
the template indicates a correspondence relation between a version of the template and a version of a disk image of the information processing apparatus included in the system,
the updating includes updating a version of the disk image of the information processing apparatus, in the template stored in the memory unit, and
the saving includes correlating the template at the time of reception of the arrangement request with a reference privilege set based on versions of a plurality of disk images having mutual dependent relations, among disk images of the information processing apparatus included in the system, the saving further including saving the correlated template.

3. The managing program according to claim 2, the process further comprising:
recording into the memory unit, the template updated in version, when the template at the time of reception of the arrangement request is correlated and saved with the reference privilege; and
setting the template to be updated at the updating to a latest version of the template among the templates stored in the memory unit.

4. The managing program according to claim 3, the process further comprising
deleting from among the templates stored in the memory unit, the template recorded before recording of the template recorded immediately before recording of the template used for arrangement of the system under arrangement.

5. The managing program according to claim 2, the process further comprising:
creating information of an update status screen showing an update status of the template, based on versions of the plurality of disk images having mutual dependent relations, among the disk images of the information processing apparatus included in the system; and
outputting the created information of the update status screen in response to reception of a request for displaying the update status screen.

6. A managing apparatus comprising:
a processor configured to:
update, in response to an update of a disk image of an information processing apparatus, a template stored in a memory unit and defining system configuration of a system that includes the information processing apparatus; and
correlate the template with a reference privilege set based on an update status of the template in response to a reception of an arrangement request and save the correlated template, in response to reception of the arrangement request for arrangement of the system using the template stored in the memory unit.

7. A managing method comprising:
updating, in response to an update of a disk image of an information processing apparatus, a template stored in a memory unit and defining system configuration of a system that includes the information processing apparatus; and
correlating the template with a reference privilege set based on an update status of the template in response to a reception of an arrangement request and saving the correlated template, in response to reception of the arrangement request for arrangement of the system using the template stored in the memory unit, wherein
the managing method is executed by a computer.
